(19) United States
(12) Patent Application Publication
(10) Pub. No.: US 2007/0009348 A1
(43) Pub. Date: Jan. 11, 2007

(54) Wind Guiding Hood Structure For Wind Power Generation

(76) Inventor: Shih H Chen, Yongkang City (TW)

Correspondence Address: HDSL, 4331 STEVENS BATTLE LANE, FAIRFAX, VA, 22033, US

(21) Appl. No.: 11/428,347

(22) Filed: Jun. 30, 2006

(30) Foreign Application Priority Data
Jul. 7, 2005 (TW) 094211516

(51) Int. Cl. F03B 15/06

(52) U.S. Cl. 415/2.1

(57) ABSTRACT

A wind guiding hood for wind power generation includes a frame, a wind guiding hood, a turbine and a wind direction detector. The turbine is installed in the wind guiding hood, and the wind guiding hood is pivotally connected into the frame. After the wind direction detector installed on the wind guiding hood detects a change in wind direction, a correct wind direction signal is transmitted to an actuator installed on the frame to drive the actuator to control the turning direction of the wind guiding hood and adjust the wind surface, so that the wind guiding hood can obtain a larger wind load for the turbine to generate electric power.

### BACKGROUND OF THE INVENTION

1. Field of the Invention

The present invention relates to a wind power generator, and more particularly to a wind guiding hood capable of detecting a change in wind direction to adjust the wind surface, so as to obtain a larger wind load for a turbine to generate electric power.

2. Description of Prior Art

A wind power generating apparatus as disclosed in R.O.C. Pat. No. M250048 and used for obtaining the wind energy from a wind flow and converting the wind energy into usable electric energy comprises: a base; a frame erected from the base; a plurality of partitions installed in the frame to define a plurality of wind collecting partitions arranged in a grid nested shape, and each wind collecting partition has a windward opening for allowing wind to flow inward and a leeward opening for wind to flow outward; a plurality of wind wheels installed in the wind collecting partitions respectively, and each wind wheel includes a hub and a plurality of radiating vanes disposed around the circumferential surface of the hub, and the vanes can be set into action by the wind entering the corresponding wind collecting partition to obtain the wind energy from the wind and convert wind energy into mechanical energy; and an electric generating unit coupled to the plurality of wind wheels for receiving the mechanical energy transmitted from the plurality of wind wheels to drive and generate electric energy.

Although the foregoing wind power generating apparatus can be driven by the plurality of electric generating units connected to the plurality of wind wheels to generate electric power, the wind entering the windward opening and exiting the leeward opening in the wind collecting partition drives the wind wheel to rotate the vanes, when the wind power generating apparatus is used. Since the base and the frame in conjunction with the plurality of partitions of the wind power electric generating apparatus define a wind collecting partition substantially in a grid nest form, a windward side must be selected first. However, the wind direction is not necessarily coming from the front side, and thus the positions of the windward opening and leeward opening cannot be changed according to the wind direction after they are fixed at predetermined positions. When wind blows from the side, the wind collecting partition cannot have provide a larger wind surface, and the vane cannot absorb larger wind energy effectively. As a result, the efficiency of electric generation is lowered.

### SUMMARY OF THE INVENTION

In view of the foregoing shortcomings of the prior art, the inventor of the present invention based on years of experience in the related industry to conduct experiments and modifications, and finally designed a feasible solution to overcome the shortcomings of the prior art.

Therefore, the present invention is to overcome the foregoing shortcomings and avoid the existing deficiencies of the prior art by providing a wind guiding hood for wind power generation, wherein the wind guiding hood can be adjusted according to a change in wind direction and turned to adjust the wind surface, so that the wind guiding hood can obtain a larger wind load for the turbine to generate electric power.

The improved wind guiding hood for wind power generation of the invention comprises: a frame, a wind guiding hood, a turbine and a wind direction detector. The turbine is installed in the wind guiding hood, and the wind guiding hood is pivotally connected into the frame. After the wind direction detector installed on the wind guiding hood detects a change in wind direction, a correct wind direction signal is transmitted to an actuator installed on the frame to drive the actuator to control the turning direction of the wind guiding hood and adjust the wind surface, so that the wind guiding hood can obtain a larger wind load for the turbine to generate electric power.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of the disassembled structure of the present invention;

FIG. 2 is a perspective view of the assembled structure of the present invention;

FIG. 3 is a cross-sectional view of the present invention;

FIGS. 4 and 5 are schematic views of an application of the present invention; and

FIG. 6 is a perspective view of another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

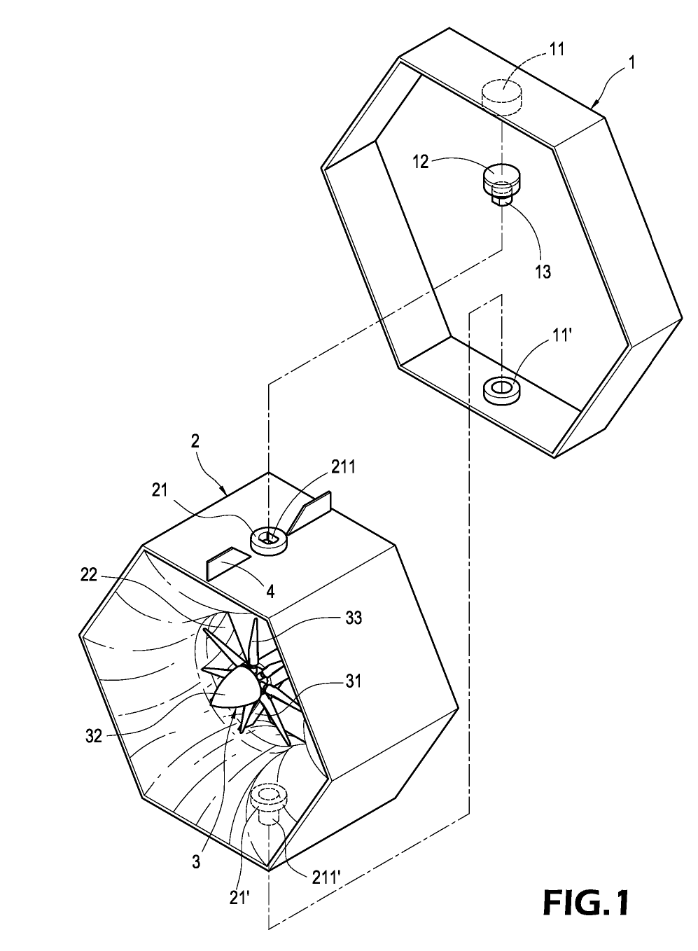

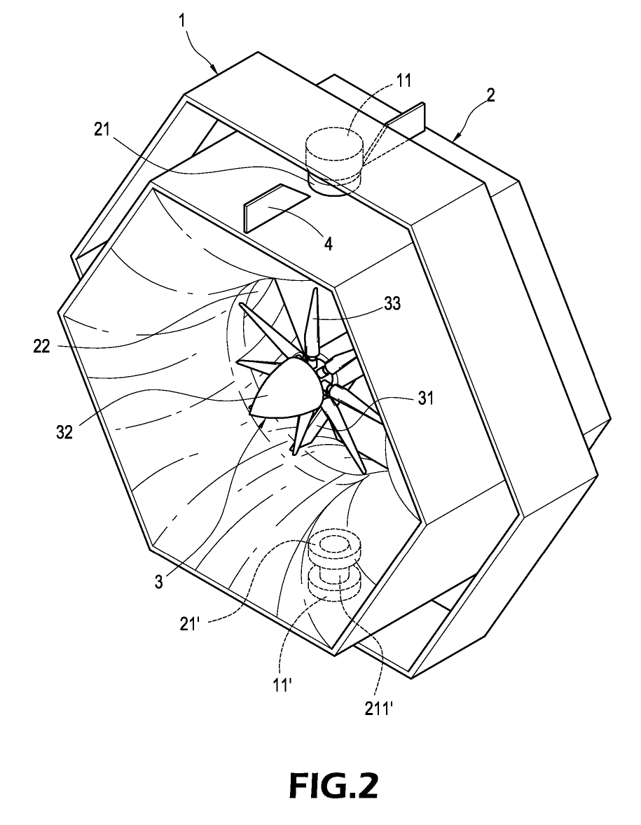

Referring to FIGS. 1 to 3 for the schematic views of the disassembled structure, the assembled structure and the cross-sectional view of the present invention, the improved wind guiding hood structure for wind power generation in accordance with the invention comprises a frame 1, a wind guiding hood 2, a turbine 3 and a wind direction detector 4, wherein the wind surface of the wind guiding hood 2 can be turned and adjusted in the frame 1, so that the wind guiding hood 2 can obtain a larger wind load for the turbine 3 to generate electric power.

The frame 1 includes two corresponding joint portions 11, 11′, and the joint portion 11 includes an actuator 12 installed thereon, and the actuator 12 has a transmission shaft 13. The actuator 12 is a stepping motor or a servomotor, and the frame 1 has a thickness smaller than that of the wind guiding hood 2.

The wind guiding hood 2 is pivotally installed in the frame 1, and the top and bottom of the wind guiding hood 2 separately include a connecting portion 21, 21′, and one of the connecting portions 21 has a connecting hole 211 for connecting the transmission shaft 13 of the actuator 12, and the other connecting portion 21′ has an axle portion 211′ extended from the joint portion 11′. Further, the wind guiding hood 2 includes a channel 22 therein and the channel 22 is designed with either an inwardly tapered internal diameter or a cambered internal wall.

The turbine 3 is installed in the channel 33 on the wind guiding hood 2, and the turbine 3 comprises a support stand 31 disposed in the wind guiding hood 2, a nose cone 32 pivotally installed at the nose cone 32 on the support stand 31 and a vane 33 rotated with the nose cone 32.

The wind direction detector 4 is installed at the top of the wind guiding hood 2 for detecting a wind direction and outputting a detected signal to the actuator 12 for controlling the actuator 12 to drive the wind guiding hood 2 to turn, so that the wind guiding hood 2 can be turned to a position with a maximum wind surface to obtain a larger wind load for the turbine 3 to generate electric power.

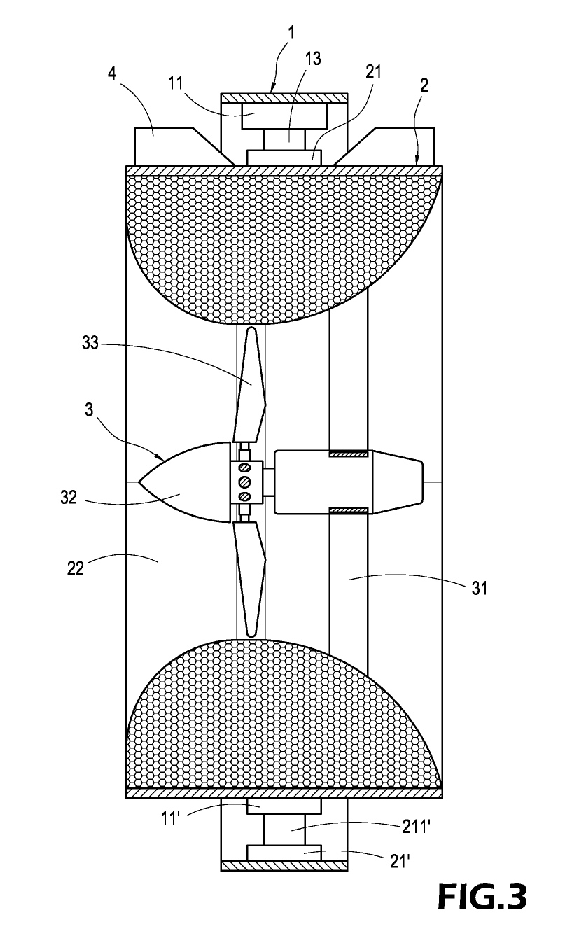

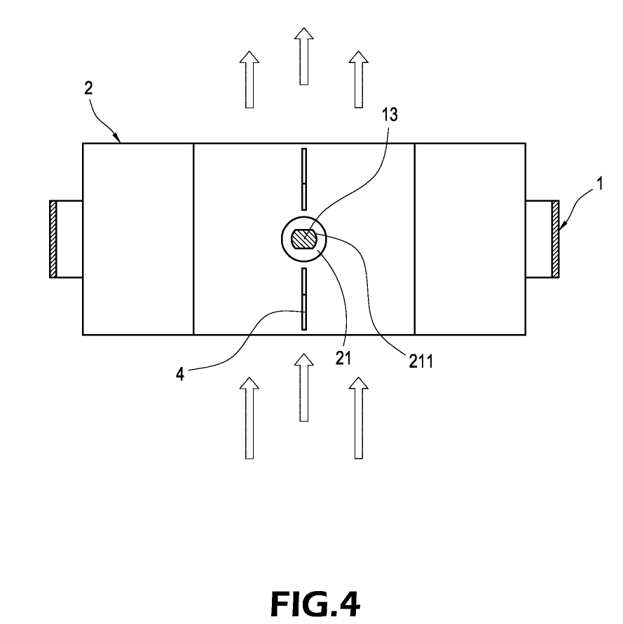

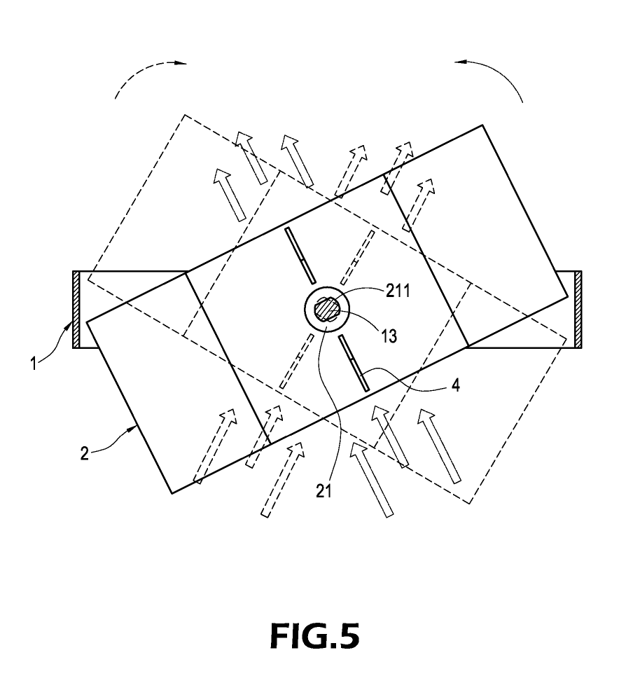

Referring to FIGS. 3 to 5 for the schematic cross-sectional views of the application of the present invention, wind blows from the front side of the wind guiding hood 2, and the wind flow is expedited when passing the wind guiding hood 2 with either an inwardly tapered internal diameter or a cambered internal wall, so as to enhance the motive force for the turbine 3 to rotate and generate electric power.

Since the wind direction detector 4 detects the wind direction all the time, therefore the wind direction detector 4 will output a detected signal to the actuator 12 if the wind direction detects a change in wind direction. After the actuator 12 receives the detected signal, the wind guiding hood 2 is controlled to turn to a correct wind direction. For instance, if the wind direction detector 4 detects a wind coming from the northwest, then the actuator 12 will control the wind guiding hood 2 to turn towards the northwest direction, and adjust the wind surface of the wind guiding hood 2 to allow the turbine 3 to continue its rotation for generating electric power. Thus, the operation of the turbine will not be stopped and the electric power generation will not be slowed down due to a change in wind direction.

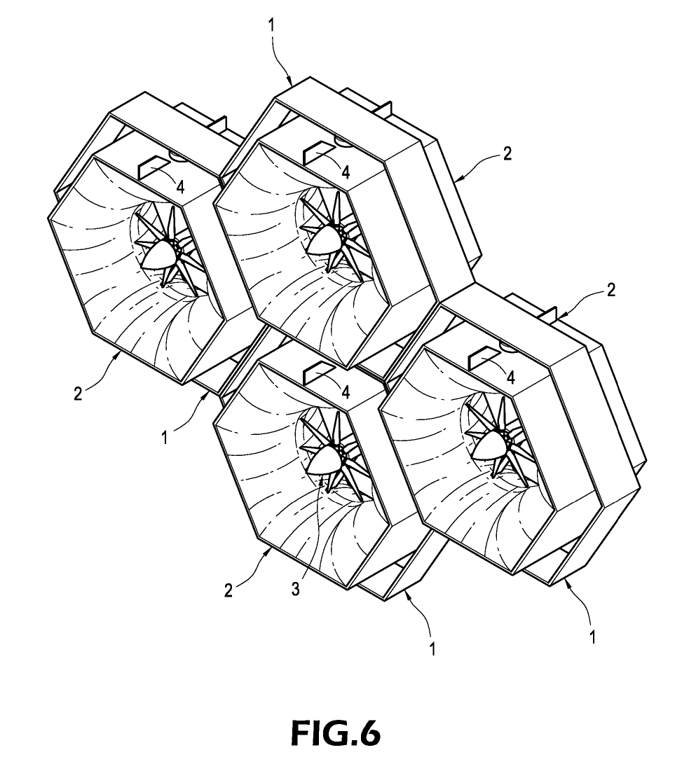

Referring to FIG. 6 for a schematic view of another preferred embodiment of the present invention, a plurality of fames 1 connected with each other can be used in the invention, so that a plurality of small electric generators form a large electric generator, and a plurality of wind guiding hoods 2 can adjust the wind surface of every turbine 3 for its rotation for generating electric power simultaneously according to the results detected by the wind direction detector 4, so as to produce a larger electric power output.

Further, the wind direction detector 4 can be installed on a control box outside the frame 1 or the wind guiding hood 2.

Further, the actuator 12 can control the wind guiding hood 2 to turn at least 180 degrees to adjust the wind guiding hood 2 to the best wind surface, without interfering with the structures of the wind guiding hood 2 and the frame 1.

In summation of the above description, the invention herein enhances the performance than the conventional structure and further complies with the patent application requirements.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A wind guiding hood structure for a wind power generation, used for detecting a wind direction and adjusting a wind surface of a turbine, and the wind guiding hood comprising:
a frame, having an actuator and a transmission shaft extended from the actuator;
a wind guiding hood, pivotally coupled into the frame; and
a wind direction detector, disposed on the wind guiding hood, for detecting the wind direction and driving the actuator to control the turning direction of the wind guiding hood and adjusting the wind surface.

2. The wind guiding hood structure for a wind power generation of claim 1, wherein the frame includes symmetrical joint portions, and the actuator is installed in one of the joint portions.

3. The wind guiding hood structure for a wind power generation of claim 1, wherein the frame has a thickness smaller than that of the wind guiding hood.

4. The wind guiding hood structure for a wind power generation of claim 1, wherein the wind guiding hood includes symmetric connecting portions, and one of the connecting portions has a connecting hole coupled to the transmission shaft of the actuator and another connecting portion has an axle portion extended from another joint portion of the frame.

5. The wind guiding hood structure for a wind power generation of claim 1, wherein the wind guiding hood has a channel.

6. The wind guiding hood structure for a wind power generation of claim 5, wherein the channel has an inwardly tapered internal diameter.

7. The wind guiding hood structure for a wind power generation of claim 5, wherein the channel has a cambered internal wall.

8. The wind guiding hood structure for a wind power generation of claim 5, wherein the channel has a turbine installed therein.

9. The wind guiding hood structure for a wind power generation of claim 8, wherein the turbine comprises a support stand installed in the wind guiding hood, a nose cone pivotally coupled onto the support stand, and a vane rotated together with the nose cone.

10. The wind guiding hood structure for wind power generation of claim 1, wherein the wind direction detector is installed on the frame.

11. The wind guiding hood structure for a wind power generation of claim 1, wherein the wind direction detector is installed on a control box outside the wind guiding hood and the frame.

12. The wind guiding hood for a wind power generation of claim 1, wherein a plurality of frames are connected with each other, such that a plurality of small electric generators form a large electric generator.
